(19) United States
(12) Patent Application Publication
(10) Pub. No.: US 2006/0208524 A1
(43) Pub. Date: Sep. 21, 2006

(54) Tonneau cover system

(76) Inventors: Jeffery O. Brown, North Logan, UT (US); Gary Rippberger, Fremont, OH (US)

Correspondence Address: THORPE NORTH & WESTERN, LLP., 8180 SOUTH 700 EAST, SUITE 200, SANDY, UT, 84070, US

(21) Appl. No.: 11/347,027

(22) Filed: Feb. 3, 2006

Related U.S. Application Data
(60) Provisional application No. 60/650,159, filed on Feb. 3, 2005.

(51) Int. Cl. B60P 7/02

(52) U.S. Cl. 296/100.01

(57) ABSTRACT

A support frame clamp for a truck bed tonneau covering system comprises a hanger, slidably adjustable within a support bow configured to span two side rails of a truck bed to support a tonneau cover over the truck bed. A clamp assembly is operable to engage a portion of one of the side rails of the truck. A connector interconnects the clamp assembly and the hanger.

Priority is claimed of copending U.S. Provisional Patent Application No. 60/650,159, filed Feb. 3, 2005, which is hereby incorporated herein by reference.

### FIELD OF THE INVENTION

The present invention relates generally to tonneau cover systems. More particularly, the present invention relates to tonneau cover systems that can be removably clamped on or over the bed of a truck.

### RELATED ART

Pickup trucks provide a mode of transportation that allows a driver of the pickup to transport items and/or materials in the bed of the truck. While the beds of pickup trucks can be advantageously used for a variety of hauling and storage uses, an open pickup bed can have a sometimes significantly disadvantageous affect on aerodynamic performance and fuel efficiency of the truck. Also, items stored in an open pickup truck bed are often subject to weather conditions such as exposure to sun, rain, snow, wind and other adverse conditions which may damage or otherwise adversely affect such stored items.

As a result of these considerations, a variety of covering systems have been developed that provide protective covers for truck beds. Such systems include what have become known as truck bed tonneau covering systems. Truck tonneau covering systems can include rigid or flexible cover materials that can be attached to or over truck beds in a variety of manners.

As tonneau systems are often not designed to be permanent additions to truck beds, they often include attachment systems that allow the tonneau framework to be removably attached to or over the truck bed. Removable attachment systems are often designed with competing objectives: to provide an attachment system that is relatively easy to install and remove, while at the same time providing a sufficiently strong attachment interface that prevents inadvertent movement of the tonneau system relative to the truck bed, or inadvertent removal of the tonneau system from the truck bed.

Thus, some conventional removable attachment systems for tonneau covers have proven overly difficult to install and remove from the truck bed as a result of the desire to ensure that the tonneau system is securely fastened to the truck bed. Other conventional removable attachment systems have proved relatively easy to install but result in an attachment interface that allows movement of the tonneau cover on or over the truck bed, which can lead to damage being done to the vehicle and/or the tonneau cover. Still other removable attachment systems have proved otherwise defective as a result of attempting to address each of these competing objectives.

### SUMMARY OF THE INVENTION

It has been recognized that it would be advantageous to develop a tonneau cover system that can be easily and securely removably attached to a truck bed.

The present invention provides a support frame clamp for a truck bed tonneau covering system, including a hanger, slidably adjustable within a support bow configured to span two side rails of a truck bed to support a tonneau cover over the truck bed. A clamp assembly can be operable to engage a portion of one of the side rails of the truck. A connector can interconnect the clamp assembly and the hanger.

In accordance with another aspect of the invention, a support frame clamp for a truck bed tonneau covering system is provided, including a clamp assembly, configured to be removably clamped to a portion of a side rail of a truck bed. The clamp assembly can include a cam housing having a cam rotatably coupled thereto. The cam can be operable to apply a clamping force between the clamp assembly and the portion of the side rail of the truck as the cam is rotated relative to the cam housing. The cam can have a continuously arcuately shaped contact surface such that a clamping force generated by rotation of the cam gradually decreases from a maximum clamping force to a holding clamping force as the clamp assembly is clamped to the portion of the side rail of the truck.

In accordance with another aspect of the invention, a truck bed tonneau covering system is provided, including a tonneau cover and a tonneau support frame assembly. The tonneau support frame assembly can include at least one tonneau side rail configured to be disposed adjacent side rails of a truck bed, and at least one tonneau cover support bow, configured to span between two side rails of the truck bed to support the tonneau cover over the truck bed. At least one support frame clamp can be operable to removably attach the tonneau cover support bow to one of the side rails of the truck bed.

Additional features and advantages of the invention will be apparent from the detailed description which follows, taken in conjunction with the accompanying drawings and claims, which together illustrate, by way of example, features of the invention.

### BRIEF DESCRIPTION OF THE DRAWINGS

FIG. 1 is a perspective view of a tonneau support frame assembly and a tonneau cover in accordance with one aspect of the invention;

FIG. 2 is a perspective view of a clamping assembly in accordance with an aspect of the present invention;

FIG. 3 is an exploded view of the clamping assembly of FIG. 2;

FIG. 4A is a side view of a cam lever assembly in accordance with an embodiment of the invention;

FIG. 4B is top view of the cam lever assembly of FIG. 4A;

FIG. 4C is an opposing side view of the cam lever assembly of FIG. 4A;

FIG. 5A is a plan view of a clamping assembly suspended from a support bow in accordance with an embodiment of the invention;

FIG. 5B is a plan view of the clamping assembly of FIG. 5A, shown in a clamped position secured to a portion of a pickup bed truck side rail; and

FIG. 6 is a perspective view of a support bow and attaching hardware in accordance with an embodiment of the invention (note that the length of the support bow is not shown to scale).

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “clamping assembly” includes one or more of such clamping assemblies.

Distances, angles, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 inch to about 5 inches” should be interpreted to include not only the explicitly recited values of about 1 inch to about 5 inches, but also include individual values and sub-ranges within the indicated range. This same principle applies to ranges reciting only one numerical value and should apply regardless of the breadth of the range or the characteristics being described.

Invention

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

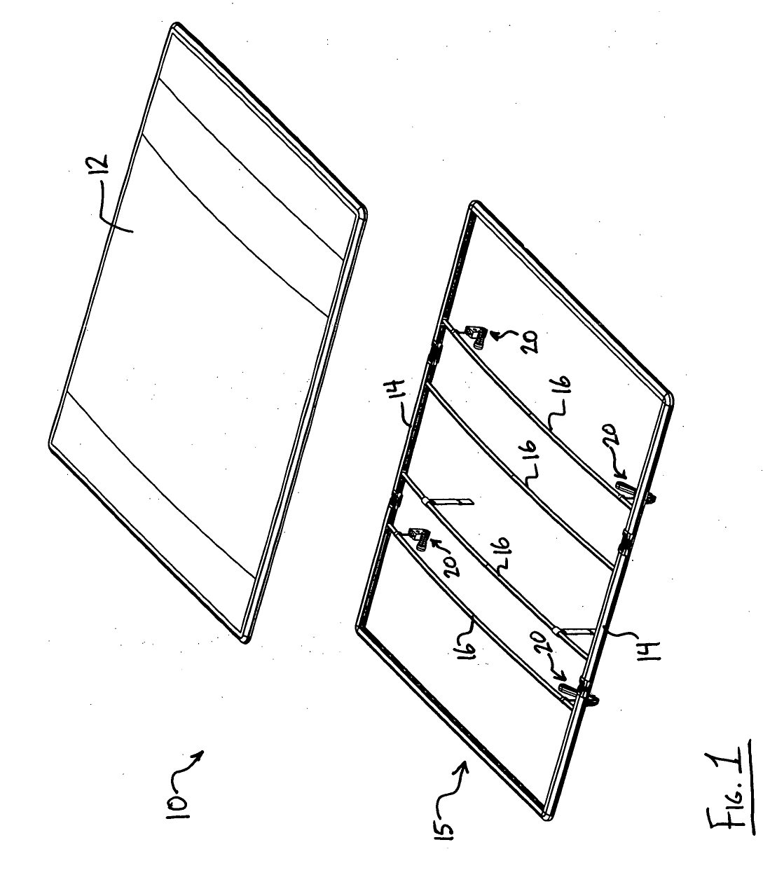

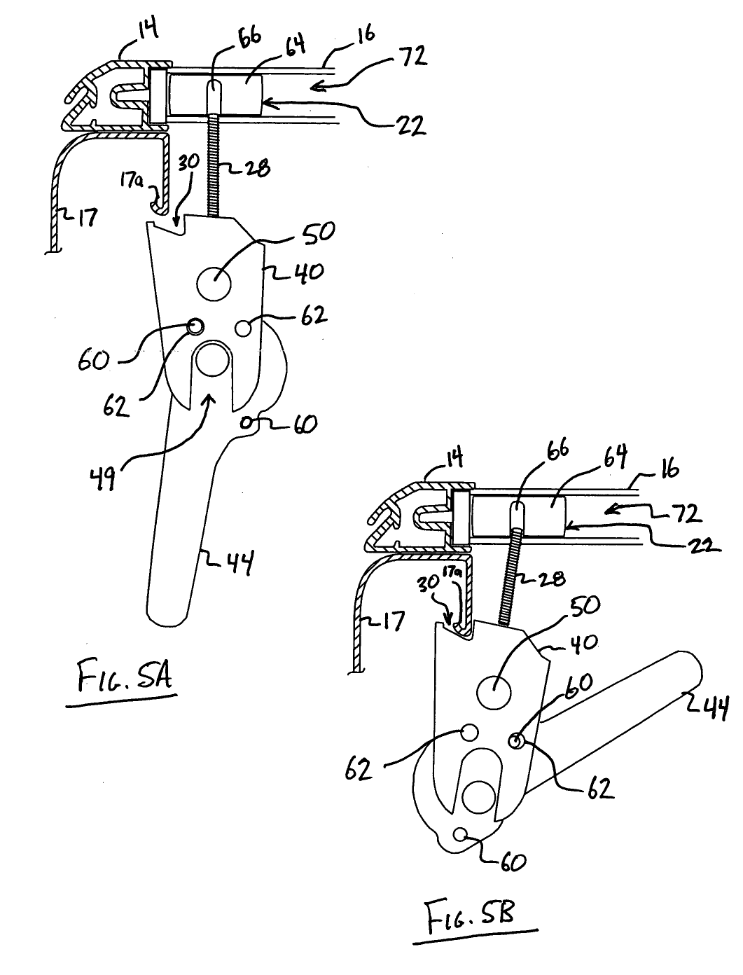

As illustrated in FIG. 1, a system, indicated generally at 10, in accordance with the present invention is shown for a truck bed tonneau covering system. The covering system can include a tonneau cover 12 and a tonneau support frame assembly (shown generally at 15). The tonneau support frame assembly can include at least one tonneau side rail 14 that can be configured to be disposed adjacent side rails (a portion of which is shown at 17 in FIGS. 5A and 5B) of a truck bed. At least one tonneau cover support bow 16 can be configured to span two side rails of the truck bed to support the tonneau cover over the truck bed. At least one support frame clamp 20 can be configured to removably attach at least one component of the support frame assembly to one of the side rails of the truck bed.

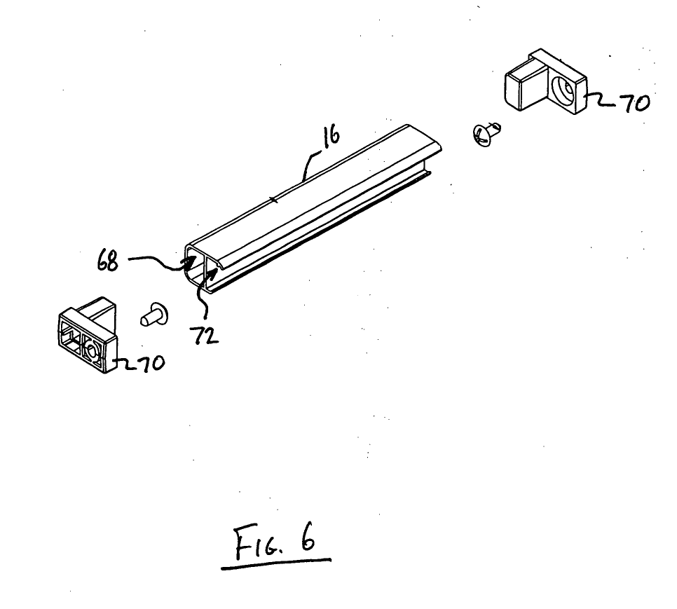

In the embodiment illustrated in FIG. 1, the support frame clamp 20 removably attaches the support bow 16 to a side rail 17 of a truck bed. As discussed in more detail below, the support bow can be coupled into the tonneau side rail 14 via attachment plugs (70 in FIG. 6). In this manner, as the support frame clamp applies force between the support bow and the side rail of the truck, the tonneau side rail is securely clamped to the side rails of the truck bed. Thus, the support frame clamp 20 can securely yet removably attach the entire tonneau cover system on or over the truck bed without requiring that portions of the side rails be directly attached to the truck bed side rails with clamping structure.

The present invention can be used with a variety of conventional tonneau systems known to those having ordinary skill in the art. In one aspect of the invention, the system can be incorporated into a folding tonneau cover that be installed onto or over a truck bed by first positioning a first section of the tonneau cover on the truck bed adjacent the truck cab. Clamps similar to those shown at 20 can attach the first section of the cover to the truck while the cover is in this initial position. Once the first section is securely clamped to the truck bed, the cover can be unfolded to position a second section of the cover on the truck bed side rails, after which clamps can be applied to secure the second section of the cover to the truck side rails (alternately, clamps may only be applied to the first and third sections). After this step, a third section can be unfolded and secured until the entire cover is securely attached on or over the truck bed.

The cover utilized with the present system can be a generally “soft” tonneau cover on a folding frame, or the present invention can be incorporated into a variety of other types of tonneau systems that are designed to be removably attached on or over a truck bed. As the clamping system of the present invention is adjustable, it can be used with a wide array of makes and models of trucks, and tonneau covers and frames, without requiring undue adjustment on the part of an operator installing the tonneau cover system.

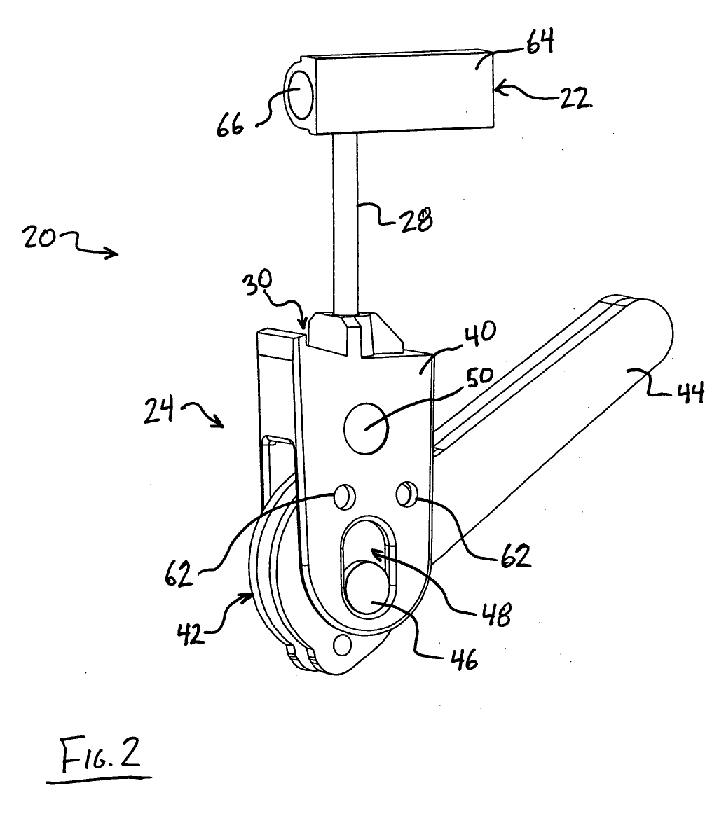

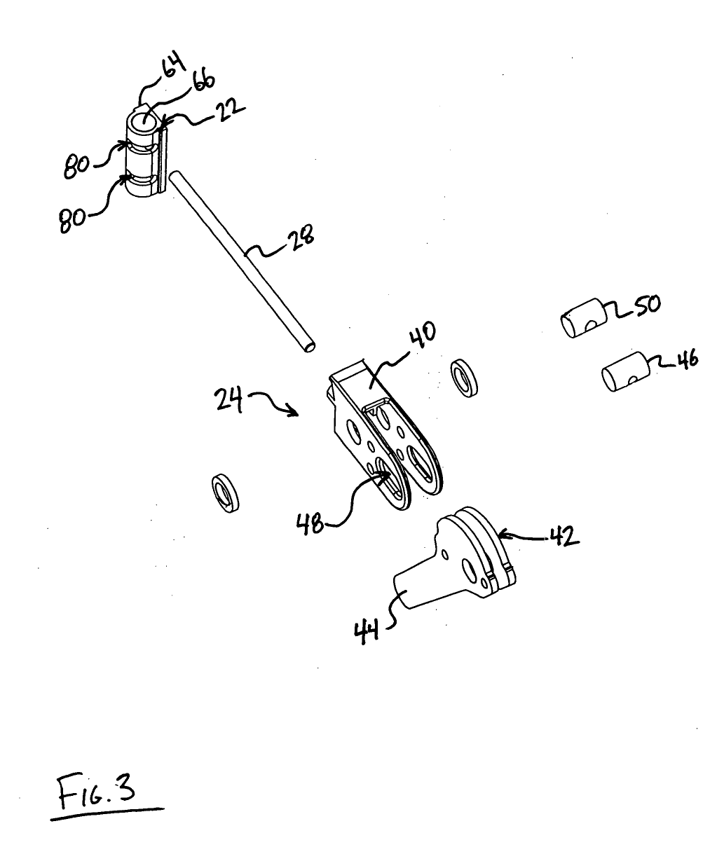

Turning now to FIGS. 2 and 3, in one aspect of the invention the support frame clamp 20 can include a hanger 22 that can be slidably adjustable within the at least one support bow 16 (not shown in these figures). A clamp assembly 24 can be configured to engage a portion (17a in FIGS. 5A and 5B) of one of the side rails of the truck, and a connector 28 can interconnect the clamp assembly and the hanger. In this manner, the hanger 22 can be slidably adjusted within or relative to the tonneau side rail (which, in use, can be coupled to or otherwise engage a truck bed side rail 14) until notch 30 formed in or on the clamp assembly is positioned to engage a generally lower portion of the truck bed side rail.

As shown in FIGS. 5A and 5B, the lower portion 17a of the truck bed side rail 17 will generally be a “rolled over” portion of the sheet metal from which the truck bed side rails are formed. This rolled over portion is commonly found on a variety of truck makes and models, and can differ from one model to another, and from one make to another, in both shape and size. The adjustability of the present clamping assembly helps ensure that the tonneau system can be utilized with a wide range of types of trucks. In the rare case where the truck manufacturer has not included structure on the truck bed side rails that can be engaged by the notch 30, it is contemplated that auxiliary structure (not shown) can be fastened to the truck bed side rail to allow the clamp to removably engage the truck bed side rail.

Shown in exploded view in FIG. 3 (and in assembled, perspective view in FIG. 2), in one exemplary embodiment of the invention, the clamp assembly 24 can include a cam housing 40 that can include a cam 42 having a cam lever 44 extending therefrom. The cam can be rotatably coupled to the cam housing. A fulcrum barrel 46 can be slidably held within the cam housing in a slot 48 to allow the fulcrum barrel to move upwardly or downwardly relative to the cam housing. The cam can rotate about the fulcrum barrel and can be engageable with a bearing 50 (in the embodiment shown, a generally barrel-shaped bearing) which can be rotatably coupled within the cam housing.

The connector 28 can be adjustably coupled or attached to the fulcrum barrel 46, and in one embodiment is threadably coupled to the fulcrum barrel. The threadable attachment provides for adjustment of a distance from the fulcrum barrel to the hanger 22. In this manner, the clamp assembly 24 can be adjusted to fit a variety of truck bed side rails, which often include side rail overhangs that vary from one model to another. The connector can be slidably disposed through the bearing barrel to enable the bearing barrel 50, and thus the cam housing 24, to move in reaction to rotation of the cam.

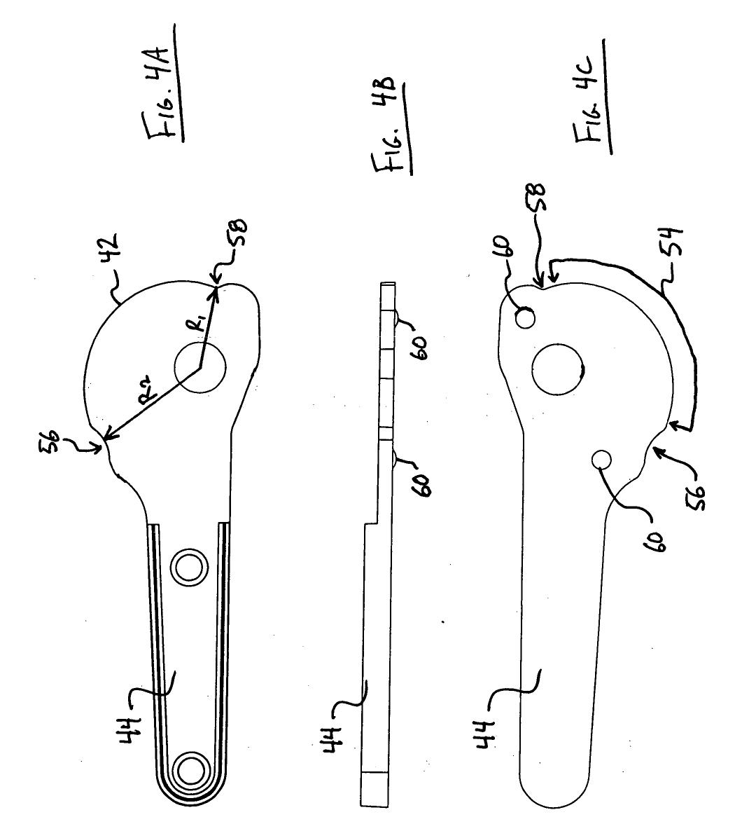

Thus, as shown in FIGS. 4A through 4C, when the cam 42 is in a released position (as shown, for example by the position of the clamp in FIG. 5A), the cam is in contact with the bearing barrel at a smaller radius R₁. As the cam is rotated about the fulcrum barrel to a clamped position (as shown, for example by the position of the clamp in FIG. 5B), the cam rotates through gradually and/or continuingly increasing larger radii to a larger radius R₂. In this manner, rotation of the cam results in a tensioning, or clamping, force being applied between the hanger and the clamp assembly.

As shown in FIGS. 5A and 5B, when the clamping assembly 24 is in the clamped position, the cam lever 44 can be oriented in a closed, upward position relative to the connector 28. In this manner, the amount of truck bed storage space that the clamp assembly consumes is minimized, resulting in greater storage space being available for storage of goods. In addition, as the cam lever does not extend downwardly into the truck bed when clamped, the likelihood of the clamping assembly becoming damaged by the storage of goods within, or the removal of goods from, the truck bed is reduced.

As best illustrated in FIGS. 4A through 4C, in one aspect of the invention the cam 42 includes a curved contact surface that is configured to smoothly engage the bearing barrel (50 in FIGS. 2 and 3) as the cam rotates to gradually increase the clamping force applied between the hanger 22 and the clamping assembly 24. The curved contact surface and the bearing barrel (which can be cylindrical in shape) provide a very smooth clamping mechanism interface which allows an operator to smoothly clamp the tonneau system to truck bed side rails. It has been found that the present system can be used to apply force at a level far exceeding that which is required to securely hold the tonneau system in place, even in the case where only a pair of clamps are used.

The curved contact surface of the cam can include a first, outwardly arching segment 54 capable of transferring a clamping force to the connector as the cam rotates, and a second, inwardly arched segment 56 configured to receive the bearing barrel 50 in a nesting relationship to interlock the cam in a clamped interlock position. The cam can also include a second inward segment 58 that can engage the bearing barrel when in a released interlock position.

The clamping assembly can thus include at least two interlocked positions, a clamped interlock position and a released interlock position. In this manner, an operator can interlock the clamp in either position and have the clamp remain in the desired position until adjusted again by the operator. In addition to the inwardly arching segments 56 and 58, the cam can include a pair of outwardly protruding cleats 60 which correspond to a pair of dimples 62 (FIGS. 2, 5A and 5B) formed in outer sides of the cam housing 40. The cleats and dimples can aid in maintaining the clamp assembly 24 in either of the clamped or the released interlock position.

In one embodiment of the invention, the cam can include a continuously arcuately shaped contact surface such that a clamping force generated by rotation of the cam gradually decreases from a maximum clamping force to a holding clamping force as the clamp assembly is clamped (e.g., attached) to the portion of the side rail of the truck. This aspect of the invention can be appreciated by viewing the curvature of the cam 42 illustrated in FIGS. 4A through 4C. As the cam transitions from contacting the bearing 50 (not shown in these figures) at the inwardly arched section 58 (at the smaller radius R1), to contacting the bearing 50 at the inwardly arched section 56 (at the larger radius R2), the change in force applied due to the rotation is always gradual.

In other words, as the cam contact surface is devoid of any sharp, sudden changes in profile, the change in force applied between the fulcrum barrel 46 and the bearing barrel 50 is consistently gradual. This aspect of the invention is advantageous in that the system is not subject to any sudden impact forces that may otherwise be present if the profile of the cam surface changed suddenly from one portion to another. It has been found that this aspect of the invention creates less stress on the components of the system and requires less force to rotate the cam into the clamped, interlocked position (e.g., when the bearing barrel is seated within inwardly arched section 56).

As best appreciated from FIG. 3, in one aspect of the invention, the hanger 22 can include an outer, slidable housing 64 that can be adjustably moveable relative to the support bow (16 in FIGS. 5A and 5B). An inner receiver 66 can be rotatable with respect to the outer housing and can receive the connector 28 therein. Thus, in this aspect of the invention, the slidable housing 64 enables the hanger to be slidably adjusted relative to or within the support bow 16 to properly adjust the clamping assembly 24 to the make and model of truck on which the cover system is to be attached. As the connector 28 is received within receiver 66, when the receiver rotates within the slidable housing 64 the clamping assembly can be laterally rotated relative to the slidable housing, and thus relative to the support bow 16.

This configuration allows the clamping assembly 24 to be rotated into an orientation substantially parallel to the tonneau side rails 14, as opposed to the operable position in which the clamping assembly is substantially perpendicular to the side rails. In this manner, the various clamping assemblies which form part of the tonneau cover system 10 can be folded within the various sections of the tonneau system as the system is folded into a storage position. The tonneau system can thus be more easily compacted for shipping and storing, and the chances of the tonneau cover 12 being punctured or otherwise damaged by the clamping assemblies while the system is folded can be reduced.

An exemplary tonneau cover support bow 16 is illustrated in FIG. 6. The bow can include an attachment channel 68 that can receive one end of an attachment plug 70 that can be attached to tonneau side rails (14 in FIG. 1). In this embodiment, the support bow can extend nearly completely from one tonneau side rail to another, forming a durable support for the tonneau cover 12. The bow can also include a slide channel 72 which can slidably receive the slidable housing 64 of the hanger 22. In this manner, the hanger 22, and thus the entire clamping assembly 24, can be slidably adjusted to nearly any position desired within the support bow. Thus, the system allows full support bow segments to span from one tonneau side rail to another while also providing nearly unlimited slidable adjustment of the clamping assemblies. This aspect is advantageous over many conventional clamping systems, which often replace segments of the bow supports with clamping devices.

In the embodiment shown in FIG. 2, the cam housing 40 includes a closed notch 48. In this aspect, the fulcrum bearing 46 is retained within the notch and prevented from sliding longitudinally from the confines of the closed notch. In the embodiment shown in FIGS. 5A and 5B, the notch 48 can include an open end 49 to allow the clamping assembly to be relatively easily dismantled.

In a similar fashion, the slidable housing 22 shown in FIG. 3 includes two access slots or openings 80 that allow the connector 28 to be attached to the receiver 66 in two distinct locations. By providing two distinct locations for attachment of the connector 28, the clamping system is provided with even further adjustability in that the clamp assembly 24 can be connected to the hanger at a location closer to or further from the side rails of the vehicle, as the configuration of any particular vehicle may dictate. However, it has been found that providing only a single slot or opening 80, as shown in the embodiment of FIGS. 5A and 5B, provides a fully operable clamping system.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A support frame clamp for a truck bed tonneau covering system, comprising:
a hanger, slidably adjustable within a support bow configured to span two side rails of a truck bed to support a tonneau cover over the truck bed;
a clamp assembly, operable to engage a portion of one of the side rails of the truck; and
a connector, interconnecting the clamp assembly and the hanger.

2. The support frame clamp of claim 1, wherein the hanger is operably positionable along the support bow in a plurality of positions.

3. The support frame clamp of claim 1, wherein the hanger includes an outer housing slidably moveable relative to the support bow, and an inner receiver rotatable with respect to the outer housing.

4. The support frame clamp of claim 1, wherein the clamp assembly includes at least two interlocked positions: a clamped interlocked position, and a released interlocked position.

5. The support frame clamp of claim 1, wherein the clamp assembly includes a cam housing having a cam rotatably coupled thereto and a cam lever extending from the cam.

6. The support frame clamp of claim 5, further comprising a fulcrum barrel rotatably coupled to the cam housing.

7. The support frame clamp of claim 6, wherein the connector is adjustably coupled to the fulcrum barrel.

8. The support frame clamp of claim 5, further comprising a bearing coupled within the cam housing, the cam having a contact surface engageable with the bearing.

9. The support frame clamp of claim 8, wherein the connector is slidably engaged through the bearing and threadably engaged with the fulcrum barrel.

10. The support frame clamp of claim 5, wherein the cam includes a curved contact surface configured to engage a bearing, the curved contact surface including a first, outwardly arching segment capable of generating a clamping force as the cam rotates, and a second, inwardly arched segment configured to receive the bearing in a nesting relationship to retain the cam in a clamped position.

11. A support frame clamp for a truck bed tonneau covering system, comprising:
a clamp assembly, configured to be removably clamped to a portion of a side rail of a truck bed, the clamp assembly including:
a cam housing having a cam rotatably coupled thereto;
the cam being operable to apply a clamping force between the clamp assembly and the portion of the side rail of the truck as the cam is rotated relative to the cam housing, the cam having a continuously arcuately shaped contact surface such that a clamping force generated by rotation of the cam gradually decreases from a maximum clamping force to a holding clamping force as the clamp assembly is clamped to the portion of the side rail of the truck.

12. The support frame clamp of claim 11, further comprising:
a hanger, slidably adjustable within a support bow configured to span two side rails of the truck bed to support a tonneau cover over the truck bed; and
a connector, interconnecting the clamp assembly and the hanger.

13. The support frame clamp of claim 12, wherein the hanger includes an outer housing slidably moveable relative to the support bow, and an inner receiver rotatable with respect to the outer housing.

14. The support frame clamp of claim 12, further comprising a fulcrum barrel rotatably coupled to the cam housing.

15. The support frame clamp of claim 14, wherein the connector is adjustably coupled to the fulcrum barrel.

16. The support frame clamp of claim 14, further comprising a bearing coupled within the cam housing, the cam having a contact surface engageable with the bearing.

17. The support frame clamp of claim 16, wherein the connector is slidably engaged through the bearing and threadably engaged with the fulcrum barrel.

18. A truck bed tonneau covering system, comprising:
a tonneau cover;
a tonneau support frame assembly, including:
at least one tonneau side rail configured to be disposed adjacent side rails of a truck bed; and
at least one tonneau cover support bow, configured to span between two side rails of the truck bed to support the tonneau cover over the truck bed; and
at least one support frame clamp assembly, operable to removably attach the tonneau cover support bow to one of the side rails of the truck bed.

19. The system of claim 18, further comprising:
a hanger, slidably adjustable within the support bow; and
a connector, interconnecting the clamp assembly and the hanger.

20. The system of claim 19, wherein the clamp assembly includes a cam housing having a cam rotatably coupled thereto and a cam lever extending from the cam.

21. The system of claim 20, further comprising a fulcrum barrel rotatably coupled to the cam housing.

22. The system of claim 21, wherein the connector is adjustably coupled to the fulcrum barrel.

23. The system of claim 21, further comprising a bearing coupled within the cam housing, the cam having a contact surface engageable with the bearing.

24. The system of claim 23, wherein the connector is slidably engaged through the bearing and threadably engaged with the fulcrum barrel.
